(19) United States
(12) Patent Application Publication
(10) Pub. No.: US 2022/0377460 A1
(43) Pub. Date: Nov. 24, 2022

(54) DUAL DIPOLE SOUND SOURCES CONFIGURATION TO MITIGATE LEAKAGE

(71) Applicant: Facebook Technologies, LLC, Menlo Park, CA (US)

(72) Inventors: Simon Porter, San Jose, CA (US); Rick Yuan Chao, Sunnyvale, CA (US); Marshall Chiu, Santa Clara, CA (US)

(21) Appl. No.: 17/327,113

(22) Filed: May 21, 2021

(51) Int. Cl. H04R 5/02; G02B 27/01; H04R 1/24

(52) U.S. Cl. CPC H04R 5/02; G02B 27/0176; H04R 1/24

(57) ABSTRACT

A dipole pair audio system (e.g., integrated into an artificial reality headset) comprising a first audio assembly and a second audio assembly. The first audio assembly is configured to generate first acoustic pressure waves, and vent the first acoustic pressure waves into a local area via a first positive vent and a first negative vent. The second audio assembly is configured to generate second acoustic pressure waves, and vent the second acoustic pressure waves into the local area via a second positive vent and a second negative vent. The first acoustic pressure waves and the second acoustic pressure waves are the same and in phase for frequencies below a threshold frequency, and are the same but are out of phase for frequencies at or above the threshold frequency.

### FIELD OF THE INVENTION

This present disclosure generally relates to audio assemblies used in headsets, and specifically to audio assemblies including dual dipole sound sources configured to mitigate leakage.

### BACKGROUND

Headsets can include assemblies configured to provide audio to a user. Some conventional assemblies implement monopole speakers where acoustic pressure waves propagate from a single surface towards an ear of the user. One disadvantage of using monopole speakers includes inefficiency of power usage as typical monopole speakers contain an enclosure with a fixed volume of air that increases the amount of work needed to drive the monopole speaker. Moreover, conventional dipole arrangements include only a single dipole. As such they do a poor job of mitigating leakage at both low frequencies and high frequencies.

### SUMMARY

The present disclosure relates to an dipole pair audio system coupled to a headset that provides audio content to a user. The headset may include one or more dipole pair audio systems (e.g., one for each ear). A dipole pair audio system includes two audio assemblies that each have a respective positive vent and negative vent. The dipole pair audio system is configured to operate in several different dipole modes. For audio frequencies below a threshold frequency, acoustic pressure waves emitted from the positive vents of each audio assembly are in phase, and acoustic pressure waves emitted from the negative vents of each audio assembly are in phase. In contrast, for audio frequencies at or above the threshold frequency acoustic pressure waves emitted from the positive vents of each audio assembly are out of phase (e.g., 180 degrees), and acoustic pressure waves emitted from the negative vents of each audio assembly are out of phase.

In some embodiments, the dipole pair audio system includes one or more pipes and anti-pipes. For example, each audio assembly may include a pipe and anti-pipe. The pipe is configured to provide acoustic pressure waves from a sound source to a vent. The anti-pipe has a same length as the pipe, but is closed on one end. The anti-pipe mitigates resonances in the acoustic pressure waves introduced by the pipe.

In some embodiments, a dipole pair audio system comprising a first audio assembly and a second audio assembly. The first audio assembly is configured to generate first acoustic pressure waves, and vent the first acoustic pressure waves into a local area via a first positive vent and a first negative vent. The second audio assembly is configured to generate second acoustic pressure waves, and vent the second acoustic pressure waves into the local area via a second positive vent and a second negative vent. The first acoustic pressure waves and the second acoustic pressure waves are the same and in phase for frequencies below a threshold frequency, and are the same but are out of phase for frequencies at or above the threshold frequency.

In some embodiments, a headset includes a first audio assembly, a second audio assembly, and a controller. The first audio assembly is configured to generate first acoustic pressure waves, and vent the first acoustic pressure waves into a local area via a first positive vent and a first negative vent. The second audio assembly is configured to generate second acoustic pressure waves, and vent the second acoustic pressure waves into the local area via a second positive vent and a second negative vent. The controller is configured to instruct the first audio assembly and the second audio assembly to generate the first acoustic pressure waves and the second acoustic pressure waves. The first acoustic pressure waves and the second acoustic pressure waves are the same and in-phase for frequencies below a threshold frequency, and are the same but are out of phase for frequencies at or above the threshold frequency.

In some embodiments, a method for generating audio content is described. A first audio assembly generates first acoustic pressure waves. A first positive vent and a first negative vent of the first audio assembly vent the first acoustic pressure waves into a local area. A second audio assembly generates second acoustic pressure waves. A second positive vent and a second negative vent of the second audio assembly vent the second acoustic pressure waves into the local area. The first acoustic pressure waves and the second acoustic pressure waves are the same and in-phase for frequencies below a threshold frequency, and are the same but are out of phase for frequencies at or above the threshold frequency.

### BRIEF DESCRIPTION OF THE DRAWINGS

FIG. 1A is a perspective view of a headset implemented as a head-mounted display, in accordance with one or more embodiments.

FIG. 1B is a perspective view of a headset implemented as an eyewear device, in accordance with one or more embodiments.

FIG. 2A is a side view of a dipole pair audio system emitting audio content in a first dipole configuration, in accordance with one or more embodiments.

FIG. 2B is a side view of the dipole pair audio system of FIG. 2B emitting audio content in a second dipole configuration.

FIG. 3A is an example audio waveguide providing audio to a vent, according to one or more embodiments.

FIG. 3B is an example audio waveguide that includes a pipe and an anti-pipe, according to one or more embodiments.

FIG. 3C is an example audio waveguide that includes a pipe and an anti-pipe in a folded configuration, according to one or more embodiments.

FIG. 4 is a system environment of an artificial reality system including a headset, in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### Overview

Audio systems presenting content to a user can have some degree of leakage. Leakage refers to audio content (i.e., acoustic pressure waves) that is detected by people/devices other than the intended recipient. For example, leakage can occur when a headset presents audio content to a wearer of the headset, and some portion of the audio content also propagates into the local area of the headset. Dipole speakers generate positive acoustic pressure waves (e.g., from a side of a diaphragm) and negative acoustic pressure waves (e.g., from the opposite side of the diaphragm). The positive acoustic pressure waves are vented into the local area via a positive vent (of a positive vent assembly), and the negative acoustic pressure waves are vented into the local area via a negative vent (of a negative vent assembly). The positive acoustic pressure waves may also be referred to as a positive acoustic source, and the negative acoustic pressure waves may also be referred to as a negative acoustic source. The positive acoustic source and/or the negative acoustic source may be, e.g., direct radiation from a diaphragm and/or from a vent.

Note that placement of the positive vent relative to the negative vent is important. If the positive vent and the negative vent are too close to each other destructive interference between the positive acoustic pressure waves and the negative acoustic pressure waves can degrade performance (e.g., diminish the bass response), but enhance leakage reduction in a far field (especially for high frequencies). However, as the distance between the positive vent and the negative vent increases, performance increases, but leakage reduction in the far field at middle and especially higher audio frequencies is reduced. As such, in conventional dipole speakers there is a tradeoff that occurs between performance and leakage reduction over the entire audio frequency range.

An audio system is described herein that uses one or more dipole pair audio systems that mitigate leakage for low, middle, and high frequencies, without sacrificing performance. A headset is configured to provide audio content to a user of the headset. The headset incorporates the one or more dipole pair audio systems (e.g., one for each ear) that each generate acoustic pressure waves received by one or more of the user's ears as audio content. A dipole pair audio system operates in a variety of dipole configurations that utilizes both positive acoustic pressure waves and negative acoustic pressure waves to create the audio content. The dipole pair audio system includes a first audio assembly and a second audio assembly. The first audio assembly is configured to generate first acoustic pressure waves, and vent the first acoustic pressure waves into a local area via a first positive vent assembly and a first negative vent assembly. The second audio assembly is configured to generate second acoustic pressure waves, and vent the second acoustic pressure waves into the local area via a second positive vent assembly and a second negative vent assembly. The first audio assembly and the second audio assembly are structured such that the first positive vent assembly and the second positive vent assembly are proximate to each other, and the first negative vent assembly and the second negative vent assembly are proximate to each other. Moreover, the distance between the positive vent assemblies is much less than the distance to either of the negative vent assemblies. Likewise the distance between the negative vent assemblies is much less than the distance to either of the positive vent assemblies.

The first acoustic pressure waves and the second acoustic pressure waves are the same and in phase for frequencies below a threshold frequency (e.g., 400 Hz kHz), and are the same but are out of phase for frequencies at or above the threshold frequency. The threshold frequency may be selected such that the audio assemblies form the first dipole configuration for frequencies below the threshold frequency (e.g., bass), and form the second dipole configuration for frequencies at or above the threshold frequency (e.g., middle and high frequencies). The threshold audio frequencies is selected such that in the far field the first dipole configuration mitigates leakage at low frequencies (e.g., bass), and the second dipole configuration addresses leakage for middle and high frequencies. Accordingly, the audio system is able mitigate leakage over the entire audio spectrum with less effect on performance (e.g., bass response).

In some embodiments, a dipole pair audio system includes one or more pipes and anti-pipes. For example, each audio assembly may include a pipe and anti-pipe. The pipe is an audio waveguide that is configured to provide acoustic pressure waves from a sound source to a vent. The anti-pipe is also an audio waveguide and has a same length as the pipe, but the anti-pipe is closed on one end. The anti-pipe mitigates resonances in the acoustic pressure waves introduced by the pipe. Conventional dipole speakers do not have the anti-pipe, as such, resonances introduced by audio waveguide between the dipoles can have a negative effect on leakage reduction.

Embodiments of the invention may include or be implemented in conjunction with an artificial reality system. Artificial reality is a form of reality that has been adjusted in some manner before presentation to a user, which may include, e.g., a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic sensation, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a handheld device, a headset (e.g., an eyewear device, a head-mounted display (HMD) assembly with the eyewear device as a component, a HMD connected to a host computer system, a standalone HMD), a mobile device or computing system, or any other hardware platform capable of providing artificial reality content to one or more viewers. In addition, the artificial reality system may implement multiple input/output devices for receiving user input which may influence the artificial reality content provided to the user.

### Headset

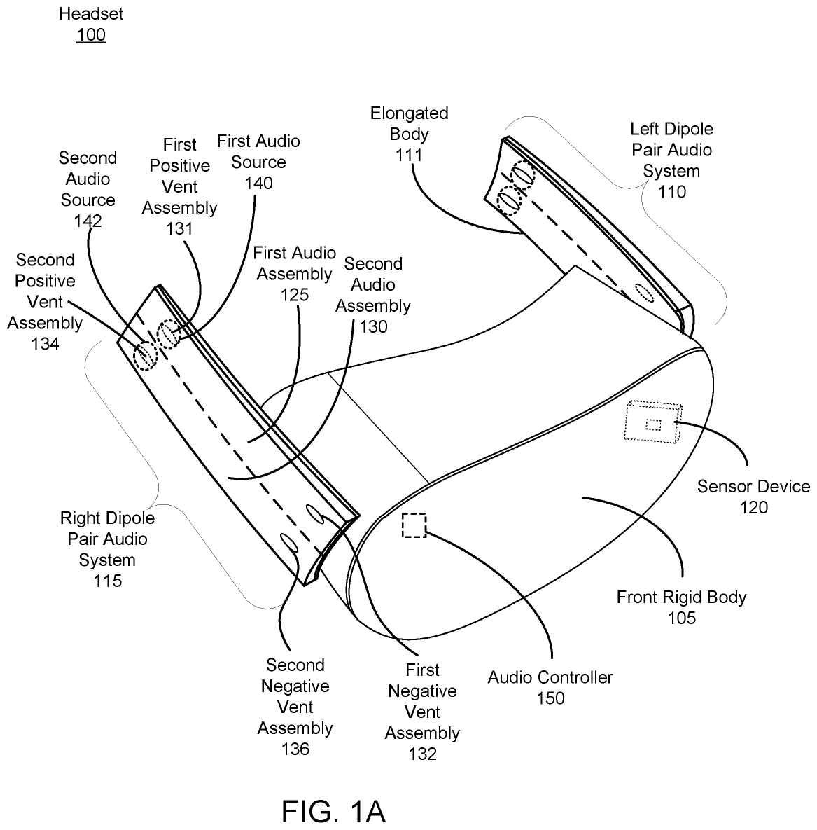

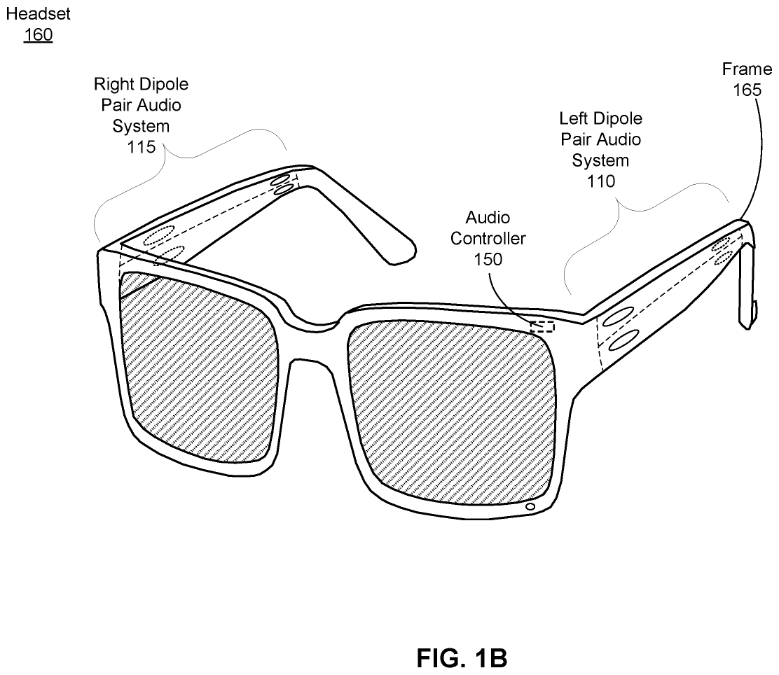

FIG. 1 is a perspective view of a headset 100, in accordance with one or more embodiments. The headset 100 presents content to a user. Examples of content presented by the headset 100 include visual content, audio content, haptic feedback content, artificial reality content, or some combination thereof. The headset 100 may be an eyewear device (e.g., form factor similar to that of a pair of eye glasses) or a head-mounted display (HMD). The headset 100 includes, among other components, a front rigid body 105, a band (not shown), a plurality of cameras (not shown), an audio system that includes two dipole pair audio systems (i.e., a left dipole pair audio system 110, and a right dipole pair audio system 115), a display system (not shown) and a sensor device 120. In other embodiments, the headset 100 may include fewer or additional components than those listed herein, a display system, haptic feedback devices, light sources, additional cameras, etc. Likewise, various operations described below may be variably distributed among components in the headset 100.

The front rigid body 105 holds the cameras, the sensor device 120, and the display system (not shown). The front rigid body 105 couples to a user's face around the user's eyes. The front rigid body 105 has a front side that is an exterior surface of the front rigid body 105 directed away from the user's body when the headset 100 is worn. The front rigid body 105 holds within the display system, such that the display system can provide visual content to the user's eyes. The front rigid body 105 is attached to a band which can be used to hold the front rigid body 105 to the user's face when the headset 100 is being worn by the user. The band (not shown) can be constructed by an elastic material providing sufficient force to hold the front rigid body 105 to the user's face.

The plurality of cameras capture images of an environment of the headset 100. The plurality of cameras are placed on an external surface of the rigid body 105. In some embodiments, the cameras are placed on a substantially similar plane with fields of view that overlap in part, e.g., at least a pair of cameras have an overlapping fields of view. In some implementations, two or more cameras of the plurality of cameras may have fully overlapping fields of view. The cameras are capable of capturing images in a plurality of light channels, e.g., luma, infrared, red, green or blue. Each camera comprises at least a camera sensor capable of detecting light but may also include any optical element for focusing the light and such. In some embodiments, the camera sensor provides image data comprising intensity values at each pixel of light detected in each of the plurality of light channels. Image data comprising images or video captured by the cameras may be presented to a user of the headset 100. Additionally, the headset 100 may augment the image data in some manner to generate augmented reality content. Image data may further be relied on in depth sensing of an environment where the headset 100 is operating in.

The audio system is configured to provide audio content to the user via dipole pair audio systems. The audio system includes the left dipole pair audio system 110, the right dipole pair audio system 115, and an audio controller 150. The dipole pair audio systems may be removably coupled to the front rigid body 105 on a left side and right side. For example, the left dipole pair audio system 110 and the right dipole pair audio system 115 may couple to the headset 100 using, e.g., a physical coupling mechanism, a magnetic coupling mechanism, or a combination thereof. Each dipole pair audio system includes two audio assemblies. Each audio assembly comprises an elongated body, audio source, a negative vent assembly, and a positive vent assembly.

The audio source generates positive and negative acoustic pressure waves. The audio source is within the elongated body. The audio source may be, for example, a speaker, a transducer, some other device including a diaphragm that vibrates to generate acoustic pressure waves, or some combination thereof. The audio source (e.g., a speaker) includes, e.g., a diaphragm that vibrates to generates acoustic pressure waves (i.e., audio content). Acoustic pressure waves generated by one side of the diaphragm are referred to as positive acoustic pressure waves, and acoustic pressure waves generated on the opposite side of the diaphragm (i.e., 180 degrees out of phase with the positive acoustic pressure waves) are referred to as negative acoustic pressure waves. The audio source may be positioned proximate to or at its positive vent assembly such that the positive acoustic pressure waves are vented into the local area (e.g., towards an ear of the user) via one or more vents of the positive vent assembly. The negative acoustic pressure waves travel through an audio waveguide within the elongated body to the negative vent assembly, and are vented into the local area via one or more vents of the negative vent assembly.

In some embodiments, the audio source may be positioned proximate to or at its negative vent assembly such that the negative acoustic pressure waves are vented into the local area via one or more vents of the negative vent assembly. The positive acoustic pressure waves travel through the audio waveguide within the elongated body to the positive vent assembly, and are vented into the local area via one or more vents of the positive vent assembly.

And in some embodiments, the audio source may be positioned relative to the positive vent assembly and the negative vent assembly such that a first audio waveguide provides positive acoustic pressure waves to the positive vent assembly and a second audio waveguide provides negative acoustic pressure waves to the negative vent assembly.

The elongated body encloses one or more audio waveguides. The audio source is configured to generate positive acoustic pressure waves and negative acoustic pressure waves within the one or more audio waveguides. The elongated body having a first end and a second end. As illustrated, the positive vent assemblies (i.e., the positive vents) are proximate to the first end, and the negative vent assemblies (i.e., the negative vents) are proximate to the second end. The audio waveguides of the elongated body direct the positive acoustic pressure waves toward the positive vent assemblies and direct the negative acoustic pressure waves toward the negative vent assemblies. The elongated body may be symmetric about its long dimension. The elongated body may further have a twist such that a first end (e.g., close to the ear of the user) of the elongated body is rotated relative to a second end (e.g., close to a temple of the user) of the elongated body. A degree of the twist may conform generally to a contour of a human head. Now that the elongated body may include one or both audio assemblies of a dipole pair audio system. For example, as illustrated a single elongated body 111 includes both the audio assemblies of the left dipole pair audio system 110 (and similarly a single elongated body includes the audio assemblies of the right dipole pair audio system 115). In other embodiments (not illustrated), a dipole pair audio system may include a separate elongated body for each audio assembly.

The negative vent assembly vents negative acoustic pressure waves, e.g., for improving bass response and leakage reduction. The negative vent assembly comprises one or more negative vents that vent negative acoustic pressure waves into free space. The negative vent assembly comprises one or more vents that are placed on a side of the elongated body that would be oriented away from the user into free space. The negative vent assembly may be positioned at or proximate to a side of the front rigid body 105 (e.g., such that it is near a temple of the user while being worn). The number of negative vents, the shape of the negative vents, the size of the negative vents, or any combination thereof may vary in various implementations. For example, one implementation may utilize four negative vents in the negative vent assembly, whereas in others there may be a single elliptical shaped vent. In some embodiments, some or all of the negative vents may include a negative vent mesh.

The positive vent assembly vents positive acoustic pressure waves for providing audio content to a user. The positive vent assembly may be positioned proximate to an ear of a wearer of the headset 100. The positive vent assembly comprises at least one positive vent that vents positive acoustic pressure waves into free space. The vented positive acoustic pressure waves are detectable by a user's ear as the audio content. In a similar manner as described for the negative vent assembly, configuration of the positive vent assembly may vary in number of positive vents, shape of positive vents, size of positive vents, or any combination thereof, which influences one or more characteristics of the vented positive acoustic pressure waves (e.g., amplitude, frequencies, reverberation, distortion, etc.). The positive vent assembly comprises one or more vents that are placed on a side of the elongated body that would be oriented towards a user's ear.

For example, the right dipole pair audio system 115 includes a first audio assembly 125 and a second audio assembly 130. The first audio assembly 125 is configured to generate first acoustic pressure waves via a first audio source 140, and vent the first acoustic pressure waves into a local area via a first positive vent assembly 131 and a first negative vent assembly 132. The second audio assembly 130 is configured to generate second acoustic pressure waves via a second audio source 142, and vent the second acoustic pressure waves into the local area via a second positive vent assembly 134 and a second negative vent assembly 136.

In some embodiments, the audio assemblies of a dipole pair audio system (e.g., the left dipole pair audio system 110 and/or the right dipole pair audio system 115) may be part of a same body (e.g., as illustrated). Alternatively, the audio assemblies may be separate structures that are coupled and/or connected together to form a dipole pair audio system. The audio assemblies are structured that as part of the dipole pair audio system their respective positive vent assemblies are proximate to each other and their respective negative vent assemblies are proximate to each other. Moreover, the distance between the positive vent assemblies is much less than the distance to either of the negative vent assemblies. Likewise the distance between the negative vent assemblies is much less than the distance to either of the positive vent assemblies.

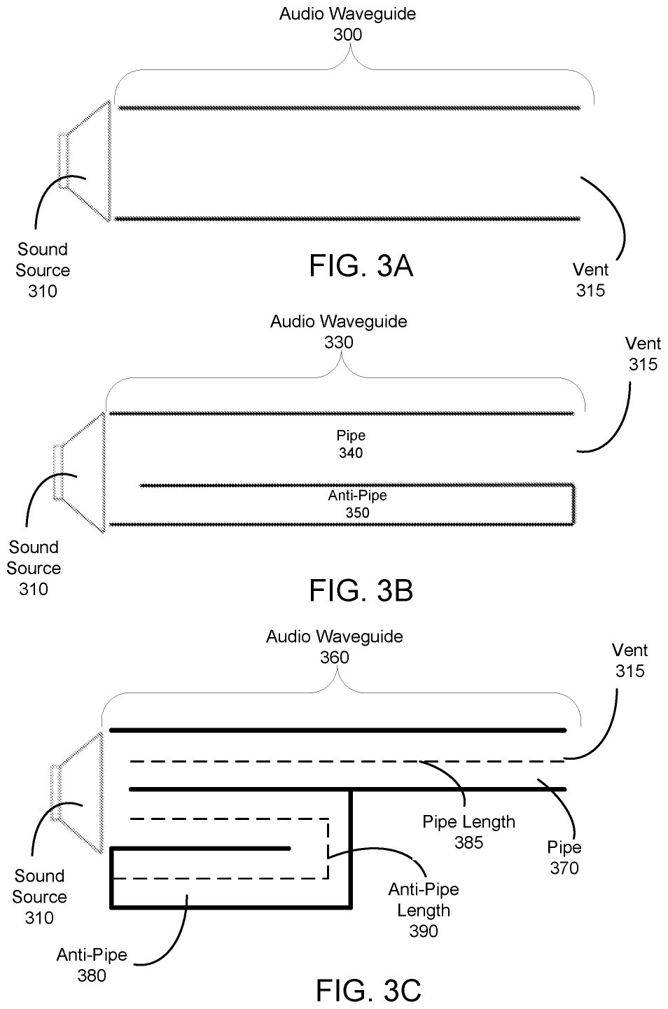

In some embodiments, one or both of the dipole pair audio systems include one or more pipes and one or more corresponding anti-pipes. For example, the first audio assembly 125 may include a pipe and anti-pipe. The pipe is an audio waveguide that is configured to provide acoustic pressure waves from a sound source to vent assembly. For example, in embodiments where the sound source is located proximate to the positive vent assembly (e.g., 131) the pipe would provide negative acoustic pressure waves generated by the sound source to the corresponding negative vent assembly (e.g., 132). Likewise, in embodiments, where the sound source is located proximate to the negative vent assembly (e.g., 132) the pipe would provide positive acoustic pressure waves generated by the sound source to the corresponding positive vent assembly (131). The anti-pipe is also an audio waveguide and has a same length as the pipe, but the anti-pipe is closed on one end. The anti-pipe mitigates resonances in the acoustic pressure waves introduced by the pipe. Conventional dipole speakers do not have the anti-pipe, as such, resonances introduced by audio waveguide between the dipoles can have a negative effect on leakage reduction. Pipes and anti-pipes are discussed in detail below with regard to FIGS. 3A-C.

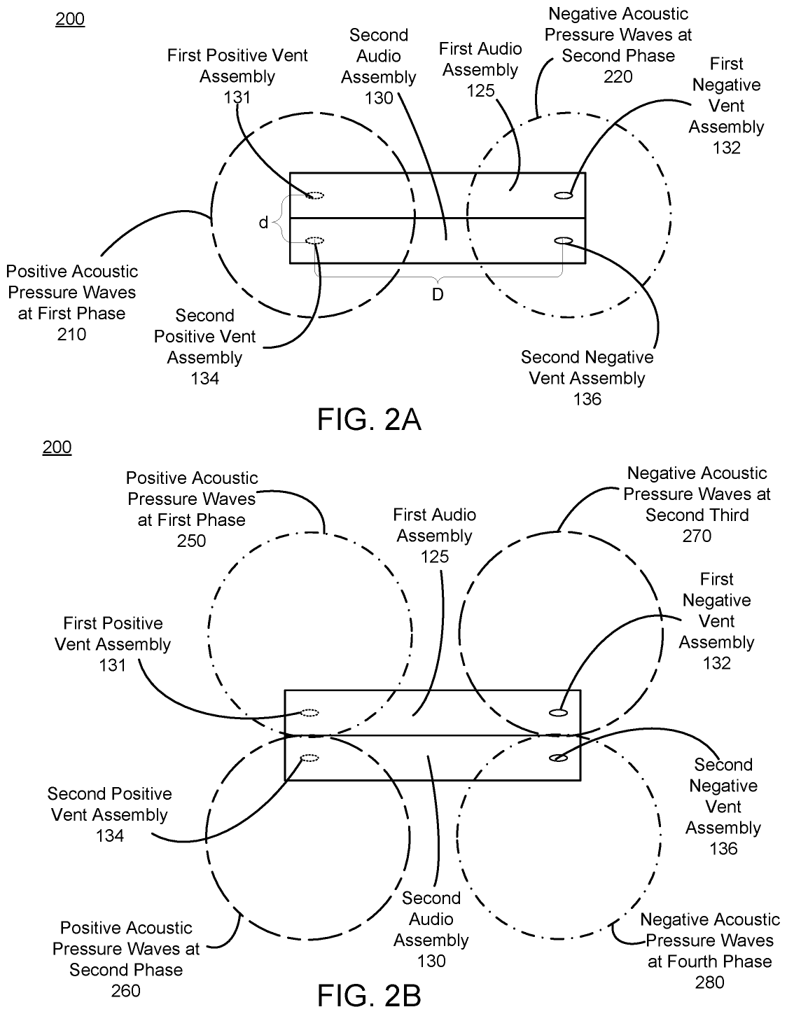

The audio controller 150 controls the dipole pair audio systems (e.g., the left dipole pair audio system 110 and the right dipole pair audio system 115). The audio controller 150 generates instruction signals for each audio source of the dipole pair audio systems based on one or more audio signals. The audio controller 150 processes the one or more audio signals such that, for a given dipole pair audio system, for frequencies below a threshold frequency the audio assemblies (e.g., the first audio assembly 125 and the second audio assembly 130) emit audio content where the acoustic pressure waves are the same and in phase—a first dipole configuration. And for frequencies at or above the threshold frequency, the audio assemblies emit the audio content with the acoustic pressure waves are the same, but out of phase (e.g., 180 degrees out of phase)—a second dipole configuration. The threshold frequency may be selected such that the first dipole configuration is for low frequencies (e.g., bass), and the second dipole configuration is for frequencies above the low frequencies (e.g., middle and high frequencies). The first dipole configuration mitigates leakage at low frequencies (e.g., bass), and the second dipole configuration addresses leakage for middle and high frequencies. The dipole pair audio systems are further described in FIGS. 2A-3C. In some embodiments, each dipole is corrected to a same target magnitude and phase at a point in space using digital signal processing before being mixed. This allows each dipole to be mixed in various amounts to control the directivity (and amount of leakage) of the system while maintaining the target magnitude and phase at the point in space.

The sensor device 120 detects movement of the headset 100. The sensor device 120 includes one or more position sensors and an inertial measurement unit (IMU). In some embodiments, the sensor device 120 is embedded into the front rigid body 105 underneath a surface layer rendering the sensor device 120 invisible to a user of the headset 100. The IMU is an electronic device that generates IMU data based on measurement signals received from one or more of the position sensors. A position sensor generates one or more measurement signals in response to motion of the headset 100. Examples of position sensors include: one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. The IMU and the position sensor will be discussed in greater detail in FIG. 5.

The display system (not shown) provides visual content. The display system has, among other components, an electronic display and an optics block. The electronic display generates image light according to visual content rendered to be presented to the user. The optics block directs the image light to an eye-box of the headset 100 where a user's eyes would be located when the headset 100 is properly worn. The display system may additional comprise other optical elements for various purposes, e.g., focusing of light, correcting for aberrations and/or distortions, magnifying light, directing light from an environment, etc. The display system will be discussed in greater detail in FIG. 5.

FIG. 1B is a perspective view of a headset 160 implemented as an eyewear device, in accordance with one or more embodiments. In some embodiments, the eyewear device is a near eye display (NED). In general, the headset 160 may be worn on the face of a user such that content (e.g., media content) is presented using a display assembly and/or an audio system. However, the headset 160 may also be used such that media content is presented to a user in a different manner. Examples of media content presented by the headset 160 include one or more images, video, audio, or some combination thereof. The headset 160 includes a frame 165, and may include, among other components, a display assembly including one or more display elements, a depth camera assembly (DCA), an audio system, and a sensor device 120. The headset 105 includes many of the same components described above with reference to FIG. 1A, but modified to integrate with the eyewear device form factor. For example, the eyewear device includes the audio system having the right dipole pair audio system 115, the left dipole pair audio system 110, and the audio controller 150. While FIG. 1B illustrates the components of the headset 160 in example locations on the headset 160, the components may be located elsewhere on the headset 160, on a peripheral device paired with the headset 160, or some combination thereof. Similarly, there may be more or fewer components on the headset 160 than what is shown in FIG. 1B.

### Dipole Audio Assembly

FIG. 2A is a side view of a dipole pair audio system 200 emitting audio content in a first dipole configuration, in accordance with one or more embodiments. The dipole pair audio system 200 is the right dipole pair audio system 115. Note that the left dipole pair audio system 110 functions in substantially the same manner, just is modified to provide audio content to the left ear of the user (v. the right ear).

The audio controller 150 (not shown) generates instruction signals for both the first audio assembly 125 and the second audio assembly 130 based on one or more audio signals. The audio controller 150 processes the one or more audio signals such that, for the dipole pair audio system 200, for frequencies below a threshold frequency the first audio assembly 125 and the second audio assembly 130 emit audio content in a first dipole configuration. The audio controller 150 also processes the one or more audio signals such that, for the dipole pair audio system 200, for frequencies at or above the threshold frequency the first audio assembly 125 and the second audio assembly 130 emit audio content in a second dipole configuration (e.g., as shown in FIG. 2B).

In the first dipole configuration, the first positive vent assembly 131 and the second positive vent assembly 134 emit respective positive acoustic pressure waves that are both the same and in-phase, these waves are positive acoustic pressure waves at a first phase 210. Similarly, the first negative vent assembly 132 and the second negative vent assembly 136 emit respective negative acoustic pressure waves that are both the same and in-phase, these waves emit negative acoustic pressure waves at a second phase 220. Note that the negative acoustic pressure waves at a second phase 220 are out of phase (e.g., 180 degrees) with the positive acoustic pressure waves at the first phase 210. The emitted positive acoustic pressure waves at the first phase 210 collectively form a first pole, and the emitted negative acoustic pressure waves at the second phase 220 for a second pole. The first pole and the second pole form the first dipole configuration for frequencies below the threshold frequency.

Note that the positive vent assemblies (131, 134) are separated from their respective negative vent assemblies (132, 136) by a distance D. And that the positive vent assembly are separated from each other by a distance d, and the negative vent assemblies are separated from each other by a distance d, where d<<D. For example, D may be in on the order of 3″ whereas d may be on the order of a 0.3″. Note that in the first dipole configuration the positive vent assemblies and the negative vent assemblies form opposite poles of the dipole and the poles are separated by D. As such base performance is good for frequencies below the threshold frequency as there is a relatively larger separation between the poles. Moreover, because the acoustic pressure waves emitted from the poles are for relatively low frequencies leakage is still mitigated in the far field. Accordingly, the first dipole configuration is able to mitigate leakage for frequencies less than the threshold frequency (e.g., 400 kHz) without sacrificing performance (e.g., bass response).

FIG. 2B is a side view of the dipole pair audio system 200 of FIG. 1B emitting audio content in a second dipole configuration. Note that the dipole pair audio system 200 emits in the second dipole configuration for frequencies at or above the threshold frequency (e.g., middle and high frequencies). In the second dipole configuration, the first positive vent assembly 131 emits positive acoustic pressure waves at a first phase 250, and the second positive vent assembly 134 emits positive acoustic pressure waves at a second phase 260. In some embodiments the waves emitted by the first positive vent assembly 131 and the second positive vent assembly 134 are the same (i.e., the shape and amplitude are the same), but the first phase is different than the second phase. For example, the first phase may be 180 degrees different than the second phase.

Similarly, in the second dipole configuration, the first negative vent assembly 132 emits negative acoustic pressure waves at a third phase 270, and the second negative vent assembly 136 emits negative acoustic pressure waves at a fourth phase 280. In some embodiments the waves emitted by the first negative vent assembly 132 and the second negative vent assembly 136 are the same (i.e., the shape and amplitude are the same), but the third phase is different than the fourth phase. For example, the third phase may be 180 degrees different than the fourth phase. Moreover, in some embodiments the first phase may be equal to the fourth phase and/or the second phase may be equal to the third phase.

Note that in the second dipole configuration, there are two dipoles that are formed. The first dipole is formed by the first positive vent assembly 131 and the second positive vent assembly 134, and the second dipole is formed by the first negative vent assembly 132 and the second negative vent assembly 136. Note that the unlike the dipole formed in the first dipole configuration, the spacing between the poles of the first dipole and the spacing between the poles of the second dipole are both d. As such the distance between the poles for the first dipole and the second dipole is much smaller than the distance between the poles (D) in the first dipole configuration discussed above with reference to FIG. 2A. As such, the first dipole and second dipole are able to mitigate leakage in the far field because the distance between the poles of the formed dipoles is relatively small.

Note that for audio content that includes frequencies below the threshold frequency and frequencies at or above the threshold frequency, the dipole pair audio system 200 may concurrently emit audio content in both the first dipole configuration and the second dipole configuration. As such, the dipole pair audio system 200 is able mitigate leakage over the entire audio spectrum with less effect on performance (e.g., bass response).

FIG. 3A is an example audio waveguide 300 providing audio to a vent 315, according to one or more embodiments. A sound source 310 emits sound, and the audio waveguide 300 guides the sound to the vent 315 through which the sound is output from the audio waveguide 300. The vent 315 may vent the sound (e.g., negative acoustic pressure waves) to a local area. In other embodiments, the vent 315 may vent the sound (e.g., positive acoustic pressure waves) toward an ear of the user. As shown the vent 315 is just an opening in the audio waveguide 300. Note that in the context of integrating the audio waveguide 300 into a headset, e.g., as part of an audio assembly (e.g., the first audio assembly 125), the audio waveguide 300 may have a geometry that introduces one or more resonances (node and/or anti-nodes) in a frequency response of the audio waveguide 300. The resonances are caused by standing waves and interference inside the audio waveguide 300. A resonance may be a node or an anti-node, and in cases where a plurality of resonances are introduced, there may be one or more nodes, one or more anti-nodes, or some combination thereof. For example, a long, thin, and relatively flat audio waveguide can have a plurality of resonances that occur in an audible frequency range. Moreover, the resonances may occur in portions of the frequency range that are vital to speech intelligibility.

FIG. 3B is an example audio waveguide 330 that includes a pipe 340 and an anti-pipe 350, according to one or more embodiments. The audio assembly 330 is an embodiment of the audio assemblies discussed above with regard to, e.g., FIGS. 1A-2B. The pipe 340 and the anti-pipe 250 are parallel to each other. The acoustic pressure waves generates by the sound source 310 propagate within the pipe 340 and the anti-pipe 350, intermingle, and are output at the vent 315. The pipe 340 is a portion of the audio waveguide 330 that is configured to provide acoustic pressure waves from the sound source 310 to the vent 315. The pipe 340 introduces one or more resonances by standing waves and interference inside the pipe 340 over its length.

The anti-pipe 350 generates resonances that generally offset the resonances produced by the pipe 340. The anti-pipe 350 has a same length as the pipe 340 and is closed on one end. As illustrated, the anti-pipe 350 has a cross section that is narrower than the pipe 340, but in other embodiments, the anti-pipe 350 may have a cross section that equals, or is wider than the pipe 340. In some embodiments, an acoustic mesh may be installed at an entrance to the anti-pipe 350. The acoustic mesh may be used to adjust damping of the acoustic pressure waves output by the anti-pipe 350 and/or the acoustic impedance (e.g., to balance the response). The anti-pipe 340 is designed such that its structure generates one or more resonances that offset a corresponding set of one or more resonances cause by the structure of the pipe 340. For example, a length and cross section of the anti-pipe may be designed such that it produces an anti-node at a specific frequency that corresponds to a frequency where the pipe 340 has a node. Accordingly, the anti-pipe 350 mitigates resonances in the acoustic pressure waves introduced by the pipe 340. The anti-pipe 350 may mitigate resonances by providing a delayed, out-of-phase wave at a target frequency.

Note that the mitigation of the one or more resonances (introduced by the pipe 340) is a passive process. In contrast, conventional methods to address resonances generally drive the speaker harder to address various resonances, which can result in higher power consumption than the system described herein. Moreover, conventional systems sometimes use a Helmholtz resonators to balance frequency response. However, Helmholtz resonators are not a valid solution for cases here, as they are only effective at addressing a single target frequency (versus a plurality of resonances that are likely to be caused by the pipe 340). Note that using an anti-pipe allows the mechanical integration to be much simpler. Implementing a single wall along the pipe (e.g., the pipe 340) not only serves to create an anti-pipe (e.g., the anti-pipe 350) but can also serve as a load-bearing rib wall to provide mechanical rigidity. Accordingly, the audio waveguide 330 allows sound to travel efficiently to the vent with a balanced frequency response, all while providing additional mechanical rigidity and not expending additional battery power.

FIG. 3C is an example is an example audio waveguide 330 that includes a pipe 370 and an anti-pipe 380 in an folded configuration, according to one or more embodiments. The audio waveguide 360 is functionally and structurally the same as the audio waveguide 330, except that the anti-pipe 380 is in a folded configuration. The pipe 370 has a pipe length 385, and the anti-pipe length 380 and an anti-pipe length 390. In a folded configuration one or both of a pipe or an anti-pipe is bent back on itself one or more times. As shown the anti-pipe 380 is in the folded configuration with a single bend that folds the anti-pipe back towards the sound source 310, but in other embodiments one or both of the pipe 370 and the anti-pipe 380 may be in respective folded configurations, and each folded configuration may include one or more bends (folding back toward and/or away from the sound source 310).

Note that in a folded configuration, generally, the pipe and the ant-pipe each have a same length. For example, as illustrated the pipe length 385 is the same length as the anti-pipe length 390. The folded configuration facilitates reducing a form factor of the audio waveguide (e.g., the audio waveguide 360) while maintaining the ability (as described above with regard to FIG. 3B) to balance a frequency response of the audio waveguide 360.

Note that FIGS. 3A-C are in the context of a single side of a dipole speaker, and the vent 315 may be, e.g., a vent of a positive vent assembly, or a vent of a negative vent assembly. And in some embodiments, side of the dipole speaker may include a pipe and an anti-pipe. For example, a pipe may be configured to provide negative acoustic pressure waves from the sound source to a negative vent, and an anti-pipe that has a same length as the pipe and is closed on one end is configured to mitigate resonances in the negative acoustic pressure waves introduced by the pipe. And in some embodiments, a pipe may be configured to provide positive acoustic pressure waves from the sound source to a positive vent, and an anti-pipe that has a same length as the pipe and is closed on one end is configured to mitigate resonances in the positive acoustic pressure waves introduced by the pipe.

### Artificial Reality System Environment

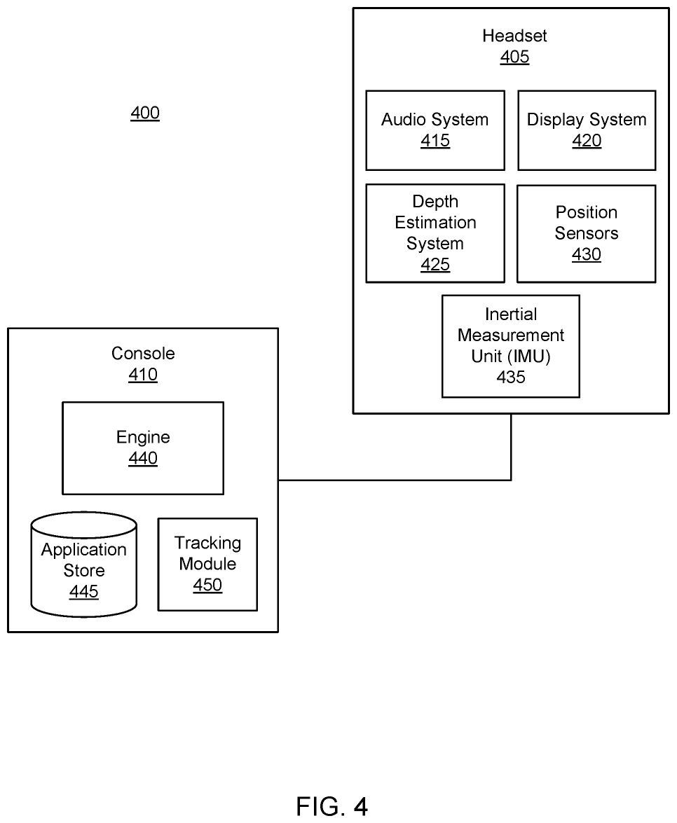

FIG. 4 is a system environment of an artificial reality system 400 including a headset 405, in accordance with one or more embodiments. The system 400 may operate in an artificial reality context, e.g., a virtual reality, an augmented reality, a mixed reality context, or some combination thereof. The system 400 shown by FIG. 4 comprises a headset 405 and may additionally include other input/output (I/O) devices (not shown) that may be coupled to a console 410. The headset 100 is one embodiment of the headset 405. While FIG. 4 shows an example system 400 including one headset 405, in other embodiments, any number of additional components may be included in the system 400. In alternative configurations, different and/or additional components may be included in the system 400. Additionally, functionality described in conjunction with one or more of the components shown in FIG. 4 may be distributed among the components in a different manner than described in conjunction with FIG. 4 in some embodiments. For example, some or all of the functionality of the console 410 may be integrated into the headset 405.

The headset 405 presents content to a user. The headset 405 may be an eyewear device, a head-mounted display, an earbud, a headphone, or another type of device placed on a head. In some embodiments, the presented content includes audio content via an audio system 415, visual content via a display system 420, haptic feedback from one or more haptic feedback devices (not shown in FIG. 4), etc. In some embodiments, the headset 405 presents virtual content to the user that is based in part on depth information of a real local area surrounding the headset 405. For example, the user wearing the headset 405 may be physically in a room, and virtual walls and a virtual floor corresponding to walls and floor in the room are rendered as part of the virtual content presented by the headset 405. In another example, a virtual character or a virtual scene may be rendered as an augmentation to views of the real world through the headset 405.

The headset 405 includes an audio system 415, a display system 420, a depth estimation system 425, position sensors 430, and an inertial measurement Unit (IMU) 435. Some embodiments of the headset 405 have different components than those described in conjunction with FIG. 4. Additionally, the functionality provided by various components described in conjunction with FIG. 4 may be differently distributed among the components of the headset 405 in other embodiments, or be captured in separate assemblies remote from the headset 405. In one or more examples, the headset 405 includes an eye-tracking system, a haptic feedback system, one or more light sources (e.g., for structured illumination light), etc.

The audio system 415 presents audio content to a user of the headset 405. The audio content may be provided by the console 410 to be presented by the headset 405. The audio system 415 comprises one or more dipole pair audio systems (e.g., one for the left ear and one for the right ear) that generate acoustic pressure waves that constitute the audio content provided to the user of the headset 405. The dipole pair audio systems may be embodiments of the right dipole pair audio system 115, the left dipole pair audio system 110, etc. A dipole pair audio system operates in a variety of dipole configurations that utilizes both positive acoustic pressure waves and negative acoustic pressure waves to create the audio content. As described above, the dipole pair audio system emits audio content in a first dipole configuration for frequencies below a threshold frequency (e.g., bass), and emits audio content in a second dipole configuration for frequencies at or above the threshold frequency (e.g., middle and high frequencies).

Additionally, in some embodiments, a dipole pair audio system (e.g., one for left ear, one for right ear, or both) includes one or more pipes and anti-pipes. For example, each audio assembly of the dipole pair audio system may include a pipe and anti-pipe. The pipe is configured to provide acoustic pressure waves from a sound source to a vent. The anti-pipe has a same length as the pipe, but is closed on one end. The anti-pipe mitigates resonances in the acoustic pressure waves introduced by the pipe.

The following process examples how the audio system 415 provides audio content. The audio system 415 obtains audio content to be provided to the user. The audio system 415 generates instruction signals for each audio source of the dipole pair audio systems based on one or more audio signals. The audio system 415 processes (e.g., via an audio controller) the one or more audio signals such that, for a given dipole pair audio system, for frequencies below a threshold frequency the audio assemblies (e.g., the first audio assembly 125 and the second audio assembly 130) emit audio content where the acoustic pressure waves are the same and in phase—a first dipole configuration. And for frequencies at or above the threshold frequency, the audio assemblies emit the audio content with the acoustic pressure waves are the same, but out of phase (e.g., 180 degrees out of phase)—a second dipole configuration.

The threshold frequency may be selected such that the first dipole configuration is for low frequencies (e.g., bass), and the second dipole configuration is for frequencies above the low frequencies (e.g., middle and high frequencies). The first dipole configuration mitigates leakage at low frequencies (e.g., bass), and the second dipole configuration addresses leakage for middle and high frequencies.

The display system 420 presents visual content to a user of the headset 405. The visual content presented may take into account depth information determined by the depth estimation system 425. The display system 420 may comprise an electronic display and an optics block. The electronic display displays 2D or 3D images to the user in accordance with data received from the console 410. In various embodiments, the electronic display comprises a single electronic display or multiple electronic displays (e.g., a display for each eye of a user). Examples of the electronic display include: a liquid crystal display (LCD), an organic light emitting diode (OLED) display, an active-matrix organic light-emitting diode display (AMOLED), a waveguide display, some other display, or some combination thereof.

The optics block magnifies image light received from the electronic display, corrects optical errors associated with the image light, and presents the corrected image light to a user of the headset 405. In various embodiments, the optics block includes one or more optical elements. Example optical elements included in the optics block include: a waveguide, an aperture, a Fresnel lens, a convex lens, a concave lens, a filter, a reflecting surface, or any other suitable optical element that affects image light. Moreover, the optics block may include combinations of different optical elements. In some embodiments, one or more of the optical elements in the optics block may have one or more coatings, such as partially reflective or anti-reflective coatings.

Magnification and focusing of the image light by the optics block allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block corrects the distortion when it receives image light from the electronic display generated based on the content.

The depth estimation system 425 determines depth information of an environment around the headset 405. The depth information may include a depth map of the environment at an instant of time. The depth estimation system 425 comprises two or more cameras and a depth controller. The depth estimation system 525 may also include one or more projectors (e.g., for structured light and/or time-of-flight). The cameras capture images of the environment—which in some cases is illuminated by the one or more projectors. With the captured images, the depth estimation system 425 can use any of numerous imaging analysis techniques to determine depth information (e.g., stereo, structured light, time-of-flight, etc.). In other embodiments, the depth estimation system 425 assesses other data received by other components of the headset 405 to determine depth information, e.g., movement. For example, the headset 405 may include proximity sensors that can be also be used alone or in conjunction with the captured images to determine depth information. The depth information determined by the depth estimation system 425 may be used to improve content presented by the headset 405.

The IMU 435 is an electronic device that generates data indicating a position of the headset 405 based on measurement signals received from one or more of the position sensors 430. A position sensor 430 generates one or more measurement signals in response to motion of the headset 405. Examples of position sensors 430 include: one or more accelerometers, one or more gyroscopes, one or more magnetometers, another suitable type of sensor that detects motion, a type of sensor used for error correction of the IMU 435, or some combination thereof. The position sensors 430 may be located external to the IMU 435, internal to the IMU 435, or some combination thereof.

Based on the one or more measurement signals from one or more position sensors 430, the IMU 435 generates head-tracking data indicating an estimated current position of the headset 405 relative to an initial position of the headset 405. For example, the position sensors 430 include multiple accelerometers to measure translational motion (forward/back, up/down, left/right) and multiple gyroscopes to measure rotational motion (e.g., pitch, yaw, and roll). In some embodiments, the IMU 435 rapidly samples the measurement signals and calculates the estimated current position of the headset 405 from the sampled data. For example, the IMU 435 integrates the measurement signals received from the accelerometers over time to estimate a velocity vector and integrates the velocity vector over time to determine an estimated current position of a reference point on the headset 405. Alternatively, the IMU 435 provides the sampled measurement signals to the console 410, which interprets the head-tracking data to reduce error. The reference point is a point that may be used to describe the position of the headset 405. The reference point may generally be defined as a point in space or a position related to the headset's 405 orientation and position.

The console 410 provides content to the headset 405 for processing in accordance with information received from the headset 405. In the example shown in FIG. 4, the console 410 includes an application store 445, a tracking module 450, and an engine 440. Some embodiments of the console 410 have different modules or components than those described in conjunction with FIG. 4. Similarly, the functions further described below may be distributed among components of the console 410 in a different manner than described in conjunction with FIG. 4. For example, the headset 405 may perform some or all of the functions of the console 410.

The application store 445 stores one or more applications for execution by the console 410. An application is a group of instructions that, when executed by a processor, generates content for presentation to the user. Content generated by an application may be in response to inputs received from the user via movement of the headset 405 or any input/output devices. Examples of applications include: gaming applications, conferencing applications, video playback applications, or other suitable applications.

The tracking module 450 calibrates the system environment using one or more calibration parameters and may adjust one or more calibration parameters to reduce error in determination of the position of the headset 405. Calibration performed by the tracking module 450 also accounts for information received from the IMU 435 in the headset 405. Additionally, if tracking of the headset 405 is lost, the tracking module 450 may re-calibrate some or all of the system environment.

The tracking module 450 tracks movements of the headset 405 as head-tracking data using information from the one or more position sensors 430, the IMU 435, or some combination thereof. For example, the tracking module 450 determines a position of a reference point of the headset 405 in a mapping of a local area based on information from the headset 405. Additionally, in some embodiments, the tracking module 450 may use portions of information to predict a future position of the headset 405. The tracking module 450 provides the head-tracking data inclusive of the estimated and/or predicted future position of the headset 405 to the engine 440.

The engine 440 also executes applications within the system environment and receives depth information from the depth estimation system 425, position information, acceleration information, velocity information, predicted future positions, or some combination thereof, of the headset 405 from the tracking module 450. Based on the received information, the engine 440 determines content to provide to the headset 405 for presentation to the user. For example, if the received information indicates that the user has looked to the left, the engine 440 generates content for the headset 405 that mirrors the user's movement in a virtual environment or in an environment augmenting the local area with additional content. Additionally, the engine 440 performs an action within an application executing on the console 410, in response to any inputs received from headset 405, and provides feedback to the user that the action was performed. The provided feedback may be visual via the headset 405. In response, the engine 440 may perform one or more of the actions in the command and/or generate subsequent content to be provided to the headset 405 based on the commands.

### Additional Configuration Information

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A dipole pair audio system comprising:
a first audio assembly configured to generate first acoustic pressure waves, and vent the first acoustic pressure waves into a local area via a first positive vent and a first negative vent;
a second audio assembly configured to generate second acoustic pressure waves, and vent the second acoustic pressure waves into the local area via a second positive vent and a second negative vent; and
wherein the first acoustic pressure waves and the second acoustic pressure waves are the same and in-phase for frequencies below a threshold frequency, and are the same but are out of phase for frequencies at or above the threshold frequency.

2. The dipole pair audio system of claim 1, wherein
the first audio assembly includes a first sound source that generates the first acoustic pressure waves, and the first sound source is proximate to the first positive vent, and the first positive vent is closer to an ear of a user than the first negative vent assembly, and
the second audio assembly includes a second sound source that generates the second acoustic pressure waves, and the second sound source is proximate to the second positive vent, and the second positive vent is closer to the ear than the second negative vent.

3. The dipole pair audio system of claim 2, wherein
the first acoustic pressure waves include first positive acoustic pressure waves produced by a first surface of the first sound source, and a first negative acoustic pressure waves produced by a second surface of the first sound source, and the first positive acoustic pressure waves are vented via the first positive vent and the first negative acoustic pressure waves are vented via the first negative vent; and
the second acoustic pressure waves include second positive acoustic pressure waves produced by a first surface of the second sound source, and second negative acoustic pressure waves produced by a second surface of the second sound source, and the second positive acoustic pressure waves are vented via the second positive vent and the second negative acoustic pressure waves are vented via the second negative vent.

4. The dipole pair audio system of claim 3, wherein
for frequencies below a threshold frequency,
the first positive acoustic pressure waves and the second positive acoustic pressure waves are the same and the first negative acoustic pressure waves and the second negative acoustic pressure waves are the same such that leakage is mitigated for frequencies below the threshold frequency, and
for frequencies at or above the threshold frequency,
the first positive acoustic pressure waves and the second positive acoustic pressure waves are the same, but out of phase 180 degrees, and the first negative acoustic pressure waves and the second negative acoustic pressure waves are the same but out of phase 180 degrees such that leakage is mitigated for frequencies at or above the threshold frequency.

5. The dipole pair audio system of claim 1, wherein the first audio assembly and the second audio assembly are both part of an elongated body of the dipole pair audio system, the elongated body having a first end and a second end, wherein the first positive vent and the second positive vent are proximate to the first end, and the first negative vent and the second negative vent are proximate to the second end.

6. The dipole pair audio system of claim 1, wherein the elongated body is part of a headset.

7. The dipole pair audio system of claim 1, wherein the first acoustic pressure waves include negative acoustic pressure waves produced by a sound source that is proximate to the first positive vent, the first audio assembly further comprising:
a pipe of configured to provide the negative acoustic pressure waves from the sound source to the first negative vent,
an anti-pipe that has a same length as the pipe and is closed on one end, wherein the anti-pipe mitigates resonances in the negative acoustic pressure waves introduced by the pipe.

8. The dipole pair audio system of claim 7, wherein the pipe and anti-pipe are parallel to each other.

9. The dipole pair audio system of claim 7, wherein the anti-pipe includes at least one bend that folds the anti-pipe back towards the sound source.

10. The dipole pair audio system of claim 7, wherein a cross sectional area of the anti-pipe is less than a cross sectional area of the pipe, and an entrance to the anti-pipe includes an acoustic mesh.

11. A headset comprising:
a first audio assembly configured to generate first acoustic pressure waves, and vent the first acoustic pressure waves into a local area via a first positive vent and a first negative vent;
a second audio assembly configured to generate second acoustic pressure waves, and vent the second acoustic pressure waves into the local area via a second positive vent and a second negative vent; and
a controller configured to instruct the first audio assembly and the second audio assembly to generate the first acoustic pressure waves and the second acoustic pressure waves, wherein the first acoustic pressure waves and the second acoustic pressure waves are the same and in-phase for frequencies below a threshold frequency, and are the same but are out of phase for frequencies at or above the threshold frequency.

12. The headset of claim 11, wherein
the first audio assembly includes a first sound source that generates the first acoustic pressure waves, and the first sound source is proximate to the first positive vent, and the first positive vent is closer to an ear of a user than the first negative vent assembly, and
the second audio assembly includes a second sound source that generates the second acoustic pressure waves, and the second sound source is proximate to the second positive vent, and the second positive vent is closer to the ear than the second negative vent.

13. The headset of claim 12, wherein
the first acoustic pressure waves include first positive acoustic pressure waves produced by a first surface of the first sound source, and first negative acoustic pressure waves produced by a second surface of the first sound source, and the first positive acoustic pressure waves are vented via the first positive vent and the first negative acoustic pressure waves are vented via the first negative vent; and
the second acoustic pressure waves include a second positive acoustic pressure waves produced by a first surface of the second sound source, and second negative acoustic pressure waves produced by a second surface of the second sound source, and the second positive acoustic pressure waves are vented via the second positive vent and the second negative acoustic pressure waves are vented via the second negative vent.

14. The headset of claim 13, wherein
for frequencies below a threshold frequency,
the first positive acoustic pressure waves and the second positive acoustic pressure waves are the same and the first negative acoustic pressure waves and the second negative acoustic pressure waves are the same such that leakage is mitigated for frequencies below the threshold frequency, and
for frequencies at or above the threshold frequency,
the first positive acoustic pressure waves and the second positive acoustic pressure waves are the same, but out of phase 180 degrees, and the first negative acoustic pressure waves and the second negative acoustic pressure waves are the same but out of phase 180 degrees such that leakage is mitigated for frequencies at or above the threshold frequency.

15. The headset of claim 11, wherein the first dipole assembly and the second dipole assembly are both part of an elongated body of a dipole pair audio system that includes the first audio assembly and the second audio assembly, the elongated body having a first end and a second end, wherein the first positive vent and the second positive vent are proximate to the first end, and the first negative vent and the second negative vent are proximate to the second end.

16. The headset of claim 11, wherein the first acoustic pressure waves include negative acoustic pressure waves produced by a sound source that is proximate to the first positive vent, the first dipole assembly further comprising:
a pipe of configured to provide the negative acoustic pressure waves from the sound source to the first negative vent; and
an anti-pipe that has a same length as the pipe and is closed on one end, wherein the anti-pipe mitigates resonances in the negative acoustic pressure waves introduced by the pipe.

17. The headset of claim 16, wherein the pipe and anti-pipe are parallel to each other.

18. The headset of claim 16, wherein the anti-pipe includes at least one bend that folds the anti-pipe back towards the sound source.

19. The headset of claim 11, wherein the headset is a head-mounted display.

20. A method comprising:
generating first acoustic pressure waves via a first audio assembly;
venting the first acoustic pressure waves into a local area via a first positive vent and a first negative vent of the first audio assembly;
generating second acoustic pressure waves via a second audio assembly;
venting the second acoustic pressure waves into the local area via a second positive vent and a second negative vent of the second audio assembly;
wherein the first acoustic pressure waves and the second acoustic pressure waves are the same and in-phase for frequencies below a threshold frequency, and are the same but are out of phase for frequencies at or above the threshold frequency.
